(19) United States
(12) Patent Application Publication
(10) Pub. No.: US 2005/0051345 A1
(43) Pub. Date: Mar. 10, 2005

(54) Fire blanket

(75) Inventors: Pamela L. Calderwood, Chapel Hill, NC (US); James R. Brock, Greensboro, NC (US); Adam Chattaway, Staines (GB)

Correspondence Address: MERCHANT & GOULD PC, P.O. BOX 2903, MINNEAPOLIS, MN, 55402-0903, US

(73) Assignee: Walter Kidde Portable Equipment, Inc., Mebane, NC (US)

(21) Appl. No.: 10/894,959

(22) Filed: Jul. 20, 2004

Related U.S. Application Data
(63) Continuation-in-part of application No. 10/203,697, filed on Nov. 8, 2002.

(30) Foreign Application Priority Data
Feb. 14, 2000 (GB) 0003349.8
Jan. 9, 2001 (GB) 0100529.7

(51) Int. Cl. A62C 8/00

(52) U.S. Cl. 169/49

(57) ABSTRACT

A fire blanket comprises two superimposed fabric layers stitched or otherwise attached together along an array of intersecting lines to form a plurality of pockets or cells. Within the cells are disposed sealed bags made of plastics material containing a chemical compound which melts and reacts endothermically when heated, such as sodium hydrogen acetate. When the fire blanket is deployed over a fire, extinguishing action takes place by exclusion of oxygen. In addition, though, the plastics material of the bags melts or ruptures to release the melted chemical compound which permeates through the porosity of the fabric and onto the fire. The bags prevent seepage of the melted chemical compound into the fabric during conditions of high temperature transport or storage and any consequent stiffening of the fabric which would reduce its efficiency of deployment. Edge regions of the blanket may be devoid of the bags to enable the blanket to be more easily draped over the fire region.

### RELATED APPLICATION

This application is a continuation-in-part of Application Ser. No. 10/203,697, filed Nov. 8, 2002, which is a 371 of PCT/GB01/00575, filed Feb. 9, 2001, which claims benefit of Great Britain application 0003349.8, filed Feb. 14, 2000, and Great Britain application 0100529.7, filed Jan. 9, 2001.

### BACKGROUND OF THE INVENTION

The invention relates to a fire blanket which is used typically to extinguish cooking oil fires. The conventional approach to extinguishing cooking oil fires (and like fires) is to use a fire blanket. Such fire blankets rely on the exclusion of oxygen to extinguish the fire. Such blankets must therefore be made of material which is, or is modified to be (such as by applying a suitable coating), capable of excluding oxygen during the high temperature condition in a fire. It may be difficult to provide suitable material in a sufficiently flexible form to enable effective deployment.

In a cooking oil fire, the burning of the oil can raise its temperature to more than that needed for auto-ignition. When a conventional fire blanket is used, therefore, the fire may re-strike if oxygen is allowed back into contact with the oil (after removal of the blanket).

In order to overcome these problems, it has been proposed to introduce chemically active extinguishing compounds into a fire blanket so that the fire blanket no longer relies entirely on the exclusion of oxygen to extinguish the fire.

### DESCRIPTION OF RELATED ART

United Kingdom Published Patent Application No. 2,359,020 (being the publication of the United Kingdom application corresponding to the above-mentioned parent U.S. application Ser. No. 10/202,697) discloses a fire blanket comprising two superimposed blanket layers (e.g. layers of a suitable fabric) which are stitched together with a suitable chemically active extinguishing compound held between the fabric layers, ready for deployment through the fabric onto the fire. More specifically, there is disclosed an arrangement in which the two blanket layers are stitched together to form a “quilted” configuration comprising a pattern of rectangular pockets or cells, each holding a quantity of the compound. Although such a blanket has been found to be very effective, it is less suitable for conditions where it may be subjected to elevated temperatures during transport or storage. Under such conditions, the chemical compound may soften into the form of a wet paste which then migrates into the fibres of the blanket fabric, rendering the blanket stiff and difficult or impossible to deploy subsequently. The present invention aims to overcome this problem.

Fire blankets are normally mounted in the risk area (such as a kitchen) by being folded up into a shallow box or container which is wall-mounted, the blanket being provided with pull tags attached to it by means of which the blanket can be rapidly pulled out of the container and then deployed on the fire. It is therefore desirable that it should be relatively easy to fold a blanket for insertion into the container or box, not only during the final stage of manufacture of the blanket but also after sale—such as after the blanket has been removed from its container for routine checking and inspection.

It can be difficult to fold the first-proposed blanket in order to match the shape of the mounting container or box into which it is to be inserted, because the blanket can in practice only be folded along the strips of material between the pockets or cells.

U.S. Pat. No. 5,032,446 (Sayles), issued Jul. 16, 1991, shows a fire blanket comprising two sheets of superimposed plastics material secured together so as to form a quilted configuration of an array of pockets, with each pocket containing a chemically active extinguishing agent. When deployed over a fire, the plastics material melts to release the chemical compound onto the fire. Here, the blanket being made only of plastics material, melts substantially immediately in the presence of the fire and there is effectively no oxygen-exclusion function. In addition, such a blanket is very difficult to fold and appears intended for semi-permanent mounting in flat form immediately adjacent to a fire risk area.

### BRIEF SUMMARY OF THE INVENTION

According to the invention, there is provided a fire blanket, comprising a fire blanket, comprising a flexible substrate, a chemical compound which reacts endothermically when heated and which melts when heated above a first predetermined temperature which is less than the temperature of a fire to be attacked by the blanket, bag means made of material which ruptures when heated above a second predetermined temperature which is higher than the first predetermined temperature and lower than the temperature of the fire to be attacked, the chemical compound being held in the bag means until the rupture thereof, the bag means being supported on and by the substrate, the substrate being configured to be porous to the melted chemical compound to allow the chemical compound to permeate therethrough towards and onto the fire after rupture of the bag means and melting of the chemical compound.

According to the invention, there is further provided a method of making a fire blanket, comprising the steps of laying out a first layer of blanket material, placing thereon in predetermined positions a plurality of sealed bags of predetermined size made of plastics material which rupture when heated at least to a first predetermined temperature which is lower than the temperature of a fire to be attacked by the blanket, each sealed bag containing a chemically active extinguishing compound which reacts endothermically when heated and which melts at a second predetermined temperature lower than the first predetermined temperature, placing a second blanket layer over the sealed bags on the first layer, and attaching the two blanket layers together along lines of attachment which pass between the sealed bags, some of the lines of attachment being spaced apart and extending in a first predetermined direction and the remainder thereof being spaced apart and extending in a second, transverse direction, whereby the lines of attachment cause the layers to form pockets in which are disposed the sealed bags, the blanket material being porous to the melted chemical compound to allow permeation of the melted chemical compound through the blanket material onto the fire after rupture of the sealed bags.

### DESCRIPTION OF THE SEVERAL VIEWS OF THE DRAWINGS

Fire blankets embodying the invention, and methods according to the invention of making fire blankets, will now be described, by way of example only, with reference to the accompanying diagrammatic drawings in which:

FIG. 1 shows plots of temperature against time for different blankets under test;

FIG. 2 is a plan view of one of the blankets embodying the invention;

FIG. 3 is an enlarged and exploded cross-section on the lines III-III of FIG. 2;

FIG. 4 is an enlarged cross-section through one of the extinguishant-containing bags used in the blanket of FIGS. 2 and 3;

FIG. 5 is a side view of a container or box for the blanket;

FIG. 6 is an end view in the direction VI of FIG. 5; and

FIG. 7 shows plots of temperature against time for blankets made in accordance with FIGS. 2 to 4 and another blanket.

### DESCRIPTION OF THE PREFERRED EMBODIMENTS

Cooking oil or fat fires are a common source of fire in the home. These fires are particularly dangerous because the burning of the liquid can raise its auto-ignition temperature to more than that needed for auto-ignition. Thus, cooking oil fires have a tendency to reignite or “restrike”. Furthermore, most conventional suppression agents such as water, CO₂ foam or multipurpose dry chemicals, are ineffective against cooking oil fires.

The conventional approach to extinguishing cooking oil fires is therefore to use a fire blanket. Such fire blankets rely on the exclusion of oxygen to extinguish the fire. Often, due to the high temperatures involved (up to 360° C.), the blankets are made of woven glass fibres. Optionally, the blankets may be coated to improve exclusion of air.

Existing fire blankets have several problems. Where blankets are uncoated, the exclusion of oxygen relies entirely on the quality of the weave of the blanket. Any defects in the weave renders the blanket less effective in excluding oxygen and may allow oil vapour to escape above the blanket which may then ignite so that flame is presence above the blanket.

Where a coating is used, the blanket tends to become stiffer than a similar blanket without a coating. This reduces the effectiveness of the sealing of the blanket around the periphery of the pan containing the cooking oil fire which therefore reduces the effectiveness of oxygen exclusion. Also, the coating is usually in the form of silicon rubber which is sometimes flammable.

Even if it is possible to extinguish the fire, the burning of the oil may raise its temperature to above its auto-ignition temperature, as noted above, and therefore the fire may readily restrike if oxygen is allowed back into contact with the oil. This problem is exacerbated by the tendency for the oil to degrade during burning and thereby to have a reduced auto-ignition temperature. For example, the typical auto-ignition temperature of cooking oil (which is predominantly composed of fatty acid esters) is about 360° C. After burning, the auto-ignition temperature may become as low as 300° C.

In commercial restaurants, wet chemical agents are sometimes used instead of a fire blanket. These may be deployed either in fixed systems or in specially modified portable hand extinguishers. However, this approach is not suitable for use in the home where the simplicity and easy storage of a fire blanket is advantageous.

The solution proposed to overcome these problems is to introduce chemically active compounds into a fire blanket so that the fire blanket no longer relies entirely on the exclusion of oxygen to extinguish the fire.

Preferably, a wet or low melting temperature chemical agent such as an alkali metal salt, e.g. potassium or sodium acetate, lactate, citrate or carbonate is included in the fire blanket so that the fire blanket operates to exclude oxygen and also extinguishes the fire by chemical means. The chemically acting agent may be in the form of a low temperature melting solid or may be carried in suspension by a carrier solution such as by being in the form of an aqueous solution.

Dry chemical extinguishers have used alkali metal salts such as sodium bicarbonate for some time as described, for example, in Sheinson, RS “Fire Suppression by Fine Solid, Aerosol” proceedings of the International CFC and Halon Alternatives Conference, Washington, D.C., 24-26 Oct. 1994, pages 414-421.

In order to be effective both to exclude oxygen and for chemical suppression of a fire it will be understood that the chemical agent must approach the fire. Thus, the fabric substrate of a fire blanket, although of low permeability to air in order the exclude oxygen, should be configured to allow the melted or aqueous solution to pass through and so enter the fire to extinguish it by chemical means.

By incorporating alkali metal salts (typically sodium or potassium salts) into the blanket, advantage may be taken of the endothermic decomposition of these compounds when heated. Since the decomposition is endothermic, heat is taken out of the fire which improves cooling of the oil and therefore reduces the possibility of the fire restriking. Furthermore, the decomposition may release water which further cools the oil by evaporation. Similarly, any carrier solution may evaporate rather than drip through the blanket. Such evaporation of the carrier solution is generally a very endothermic (heat absorbing) process.

Additionally, if the salt solution is alkaline, the solution reacts chemically with the cooking oil to saponify the oil to produce a crust or lumps of generally inflammable “soap”. This further reduces the chance of re-ignition.

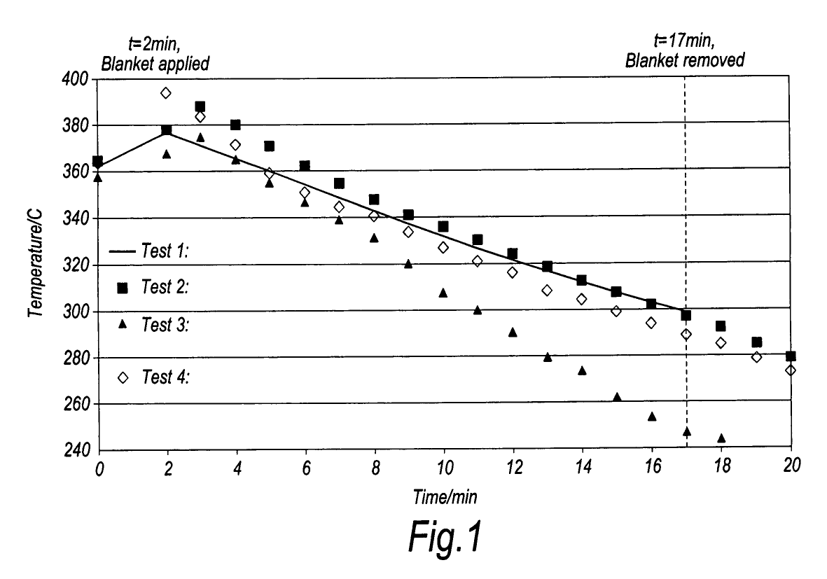

With reference to FIG. 1, the results of Tests 1 to 4 respectively using a wet fire blanket, a fire blanket pre-wetted with potassium acetate, a fire blanket pre-wetted and subsequently re-wetted with potassium acetate and a fire blanket with sodium acetate applied are shown. In each test, oil in a pan was heated to its auto-ignition temperature and allowed to burn for two minutes. The blanket under test was then applied. After a further 15 minutes, the blanket was removed. The temperature of the oil was measured during and after this period. In FIG. 1, the temperature of the oil in degrees Celsius is plotted on the vertical axis and time in minutes is plotted on the horizontal axis.

The tests have been conducted using a 285 mm aluminium pan. In all other respects the tests followed the test protocol set out in British Standard—European Norm (BSEN) 1869:1997.

Test 1—Wet Blanket

Three litres of oil in a pan were heated to auto-ignition temperature (362° C.) and allowed to burn for two minutes. A pre-soaked blanket was then applied and the pan let to stand. As expected, fire extinction occurred instantly. Control was maintained for 15 minutes thereafter until the blanket was removed. After the blanket was removed, the fire reignited after approximately 20 seconds and so failed the BS 1869:1997 test. Thus, the wet blanket was shown to be inadequate as a fire blanket, not least because it did not reduce the temperature of the oil to below its auto-ignition temperature within a reasonable length of time.

Test 2—Blanket soaked in potassium acetate solutions

The test was conducted as in Test 1. A tea towel was soaked in a 40% aqueous solution of potassium acetate to form a fire blanket before being applied to the pan. The fire was extinguished immediately and remained under control for 15 minutes. After removal at the 15 minute point, the fire did not restrike for at least 3 minutes. This constituted a pass to British/European Standard (BSEN) 1869:1997.

At the end of the test, the towel was slightly charred (but less than in Test 1). It is believed that the high concentration of potassium salts prevented the fire from causing as much damage to the underlying tea towel material.

Test 3—Blanket soaked in potassium acetate solution and then additional potassium acetate solution added after fire suppression

This test was carried out as for Test 2 but additional 40% aqueous solution of potassium acetate was periodically applied to the top of the blanket during the 15 minute control hold time after extinguishing the fire. This was expected to produce additional cooling by evaporation of the water and also more effective saponification of the oil due to the additional quantities of potassium acetate solution. During the additional application of potassium acetate solution, hissing and boiling occurred due to the flash evaporation of the aqueous solution.

The addition of about 150 ml of aqueous potassium acetate solution resulted in a much higher degree of cooling as shown in FIG. 1. The blanket appeared less charred, although the underside appeared oily due to the boiling and frothing that had occurred during the second application. A quantity of the oil residue at the end of the test was collected and analysed for saponification. A small spectral peak at 1560 cm⁻¹ was observed which indicates that some saponification had taken place. The amount of saponification does not appear to have been significant and it is likely that the major suppression mechanism in this test was cooling of the oil by the endothermic reactions described above.

Test 4—Sodium Acetate Trihydrate

Sodium acetate trihydrate has a melting point of about 58° C. and thus may be applied to the blanket or secured therein in solid form. During extinguishing, the compound melts and drops into the oil. This test was conducted as with the above tests and the fire was held extinguished for 15 minutes and did not reignite for at least 3 minutes after removal.

An examination of FIG. 1 shows that the sodium acetate trihydrate leads to a higher initial cooling rate. This may be due to the compound first melting and then losing water which are both endothermic processes.

Thus the tests show that improved extinguishing can be achieved using a “chemically active” fire blanket. The chemically active component is typically an alkali metal salt and preferably a potassium or sodium salt. Preferably, to cause saponification, the solution produced by the compound is alkaline.

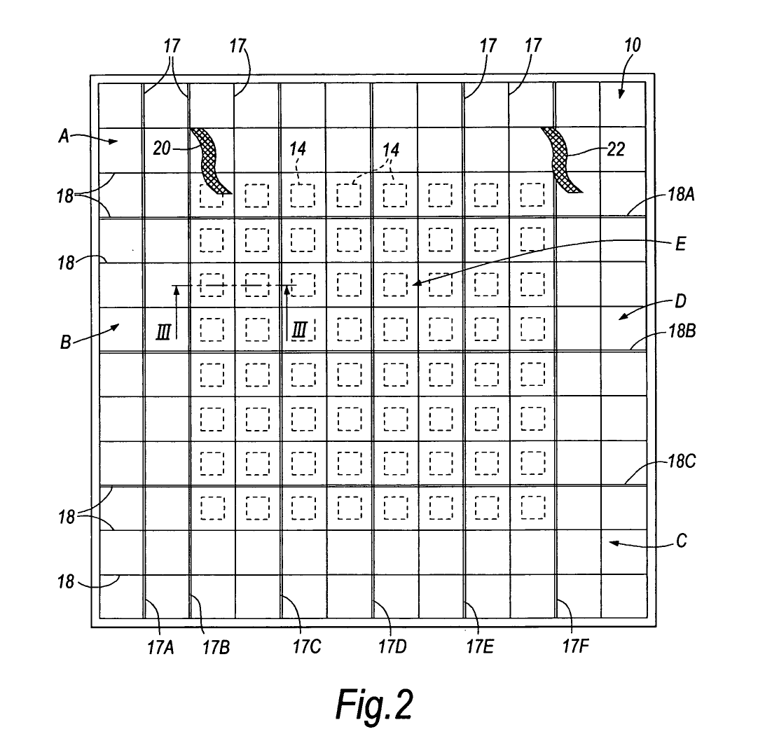

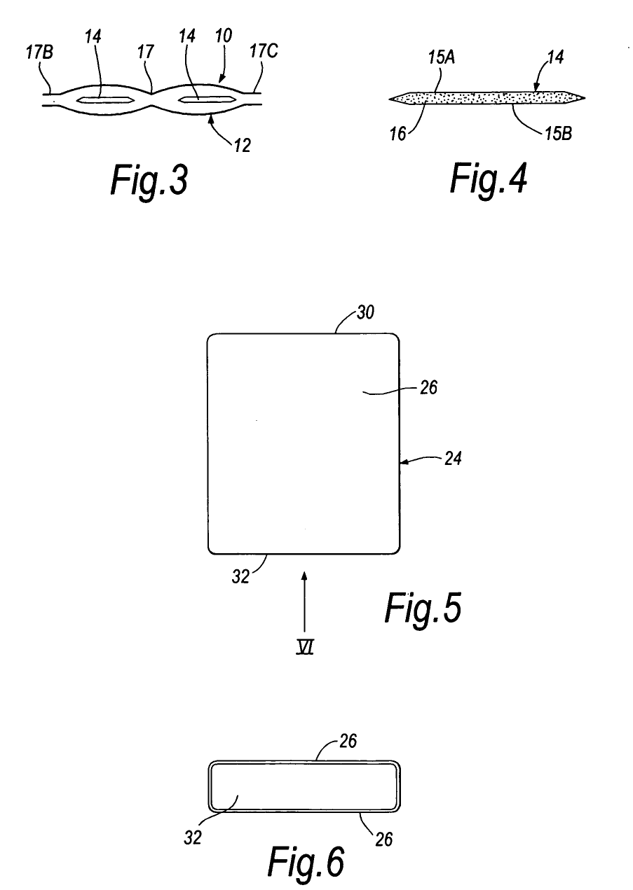

Blankets embodying the present invention will now be described in detail, with particular reference to FIGS. 2 and 3.

The blanket comprises two layers 10,12 (see FIG. 3) of a suitable fabric. A suitable fabric is lightweight cotton sheet or fibreglass material. Further details of suitable fabric are given below.

During manufacture, one blanket layer 12 is placed on a flat surface. Individual “bags”, to be described in detail below, are then placed on the lower blanket layer 12 in a rectangular array of rows and columns as shown in FIG. 2.

An enlarged diagrammatic cross-section through one of the bags 14 is shown in FIG. 4. The bag is made of upper and lower rectangular layers of suitable plastics material 15A, 15B, the edges of which are hermetically sealed to form a shallow rectangular sealed bag. In each bag is held the chemically active extinguishing compound 16. The plastics material used is low density polyethylene. Each bag is preferably square in plan view, with a side of approximately 4.5 cms and is about 0.5 centimetres thick. Typically, between 6 and 8 grams of the extinguishant may be incorporated in each bag.

After the bags have been positioned on the lower blanket layer 12, as shown in FIG. 2, the upper blanket layer 10 is superimposed. The two blanket layers are then stitched together along stitch lines arranged in a rectangular array, as shown at 17 and 18 (only some of the stitch lines being referenced). The stitching thus forms the blanket into a quilted configuration comprising a plurality of pockets or cells. Each such pocket or cell is square in plan view with a side of about 8.9 cm. As is apparent from FIG. 2, in most, though not all, of these cells is positioned a respective one of the bags 14. It will be noted that each such bag 14 is significantly smaller in size than the size of the pocket in which it is held. It will also be noted that the pockets of the edge regions A,B,C, and D of the blanket, on all four sides, are devoid of the extinguishant-filled bags 14.

The blanket is provided with “handles” 20,22, in the form of fabric strips securely stitched adjacent to one edge of the blanket.

The blanket is normally held in a shallow container or box. The box will be described in more detail with reference to FIGS. 5 and 6. The box is preferably wall-mounted in a kitchen or other risk area, the blanket being folded up inside the container but leaving the handles 20,22 protruding, normally in a downward direction. In the event of a fire situation, the user pulls on the handles to draw the blanket out of the container and it is then deployed over the fire. The edge region A,B,C and D of the blanket, being free of the extinguishant-filled bags 14, are relatively flexible and thus readily drape over the container, utensil or appliance where the fire is burning. The central region E, containing the extinguishant-containing bags 14, is thus situated immediately over the fire.

As already explained, the blanket provides an initial and continuing fire extinguishing action by excluding oxygen from the fire. In addition, however, the heat of the fire melts the extinguishant compound in the bags 14 and causes the plastics material of the bags to melt or burst. The chemical compound thus permeates through the material of the fabric (such as through the weave if the blanket is made of woven material), via a combination of capillary action and gravity. The fabric of the blanket is arranged and selected so that its original structural integrity remains intact without breakage or rupture so as to enable the released chemical compound to permeate through it. Such structural integrity also ensures that a good barrier is presented and continuously presented to stop air or oxygen reaching the hot oil fire.

The extinguishant compound 16 incorporated in the bag 14 will normally melt or liquify at about 60° C., such as in the case of sodium acetate trihydrate (and similar melting or liquifying temperatures apply to the other extinguishants mentioned). The plastics material 15A, 15B of the bags 14 melts at about 120° C. Therefore, even if the blanket should be subjected to temperatures of the order of 60° C. during transport or storage, thus causing the extinguishant compound to melt or liquify, the extinguishant compound will still be securely retained within the bags 14. The extinguishant is therefore ready for release in the manner already indicated when the blanket is deployed over a fire and the plastics material of the bag 14 rises above 120° C. and melts. In this way, the problem mentioned above, of premature release of the extinguishant compound into the blanket fabric layers when subjected to elevated temperatures during transport or storage, is completely overcome, and the risk of such release causing the blanket to become stiff and effectively unusable is therefore avoided.

It will be clear that many modifications may be made. For example, the bags 14 can be larger or smaller in relation to the size of the pockets or cells of the blanket in which they are situated. The bags 14 need not be square or rectangular in configuration but could instead be circular, for example. A particularly advantageous shape is triangular because bags of this shape can be packed very efficiently together in the blanket to give a high density of the chemical compound if required. The stitching in the blanket could be arranged to provide pockets of triangular shape as well.

It may be advantageous for the size of the bags 14 to vary over the region E, so that the bags 14 closest to the centre of this region E contain more of the extinguishant compound than those further away from the centre. In this way, the extinguishing action performed by the extinguishant compound is concentrated in the centre of the blanket, where the fire may be fiercest. The sizes of the pockets can be varied as required—such as being made smaller to increase the density of the chemical compound (for bags of a particular size).

The edge regions A,B,C and D of the blanket can be larger or smaller than shown. They may be devoid of the stitching.

If the material of the blanket layers is suitable, then the pockets or cells could be formed not by stitching along the lines 17,18 but by some other suitable process such as adhesive or welding.

The fabric material of the blanket is advantageously treated with a fire retardant. The thread used to stitch the blanket also needs to be able to withstand high temperature. Suitable material is Kevlar (Trade Mark).

FIGS. 5 and 6 show a suitable container 24 for holding the blanket ready for use. The container may have front and back faces 26 each with a length of 25 centimetres, and a width of 20 centimetres. The depth of the container may be 8 centimetres, and it may be blow-moulded from suitable material. It has a closed end 30 and an end 32 which is open to allow insertion of the folded blanket, the end 32 being closed off, after insertion of the blanket, by a press-fitted lid, one of whose edges has two shallow grooves to allow protrusion therethrough of the handles 20,22 of the blanket (as shown in FIG. 5). When a user wishes to deploy the blanket, the user tugs downwardly on the handles 20,22, thus releasing the lid and pulling the blanket out for deployment over the fire.

As stated, the blanket is placed in the container 24 in a folded configuration. A feature of the blanket being described facilitates such folding. Ease of folding is clearly advantageous for use during the final stage of manufacture. It is also a desired feature after sale of the blanket. Thus, the blanket may need to be removed from the container 24 in a non-emergency situation, for inspection or training purposes. In such cases, it is necessary of course to re-fold the blanket for insertion back into the container.

In order to facilitate such folding of the blanket, in particular regions on the blanket (see FIG. 2) the stitching is arranged along pairs of closely adjacent parallel stitch lines extending in a first direction as shown at 17A, 17B, 17C, 17D, 17E and 17F. Correspondingly, similar pairs of spaced stitch lines are provided extending in a second, perpendicular direction as shown at 18A,18B and 18C. In each of these regions two stitch lines are arranged, spaced apart by approximately 2.5 centimetres. These stitch lines provide regions along which the blanket is preferably folded. Each of the regions thus provides additional blanket material (between the parallel stitch lines) to accommodate the extra thickness of the blanket resulting from the inclusion of the bags 14 so that, during the folding operation, a bag 14 in a folded-over part of the material can be placed more or less exactly onto a bag 14 in the folded-onto blanket layer. Without the presence of these regions of double stitch lines (that is, if there were only a single stitch line in each such region) multiple folding, in order to fold the blanket down to the correct size for insertion into the container 24, could cause one or more of the bags 14 to lie along a fold line. Folding of a bag 14 being substantially impossible, the folded blanket would be disrupted. This is avoided by the double stitch line regions.

As shown in FIG. 2, the double stitch line regions 17B, 17C, 17D, 17E and 17F, and 18A, 18B and 18C define eight areas of the blanket each comprising six pockets containing bags 14, the pockets, with their bags therein, being arranged in a matrix of two columns and three rows. The area of each such matrix is slightly less than the area of the face 26 of the container 24 (see FIG. 5). During a preferred folding operation, the blanket is first folded in one direction along the region 18B and then in the opposite direction along the regions 18A and 18C, so as to leave the handles 20, 22 freely protruding. The blanket is then in the form of an elongated “strip” having a length equal to the full width of the blanket shown in FIG. 2 and a width equal to the width of three pockets. The ends of this “strip” are then folded inwardly (along appropriate ones of the double stitch line regions 17A to 17F) until the blanket presents an area corresponding to the area of one of the matrices, with the two handles 20, 22 immediately adjacent to each other. The blanket in this form can then be easily inserted into the container 24 through the open end 32 (FIG. 6). Clearly, the arrangement of the regions of double stitch lines can be changed to match any desired folding sequence and the size of the container into which the folded blanket is to be inserted.

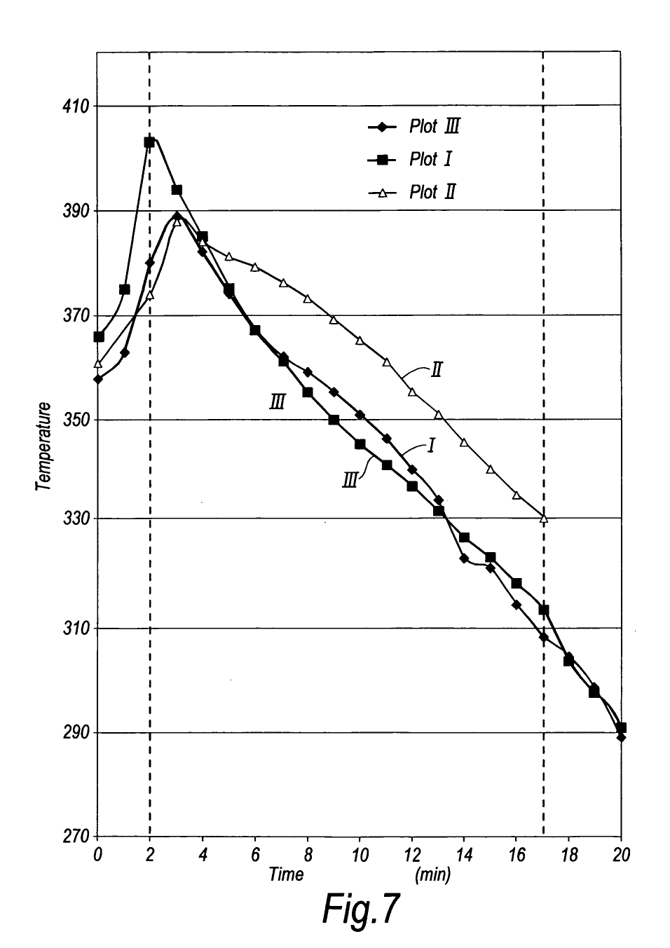

FIG. 7 shows the results of tests carried out on examples of the blanket described above with reference to FIGS. 2-4, in comparison with a conventional blanket (that is, a blanket not combining any chemically active extinguishant). In each test, a quantity of oil is subjected to increasing temperature until auto-ignition takes place. Two minutes thereafter, the blanket under test is applied over the fire.

FIG. 7 shows elapsed time in minutes along the horizontal axis (that is, time since auto-ignition of the oil) and the temperature of the burning oil in degrees Celsius along the vertical axis. Two samples of the blanket described above with reference to FIGS. 2-4 were tested, and the results of these tests are shown in plots I and III. For comparison, the results of a test carried out using a standard blanket (not incorporating any chemically active extinguishant) are shown in plot II. Auto-ignition of the oil is assumed to start at time=0. Two minutes thereafter, the blanket under test is deployed over the fire. In each case, the fire is extinguished. The temperature of the oil is measured at intervals, to produce the plots I,II and III.

It will be observed that the two blankets according to the invention, producing plots I and III, cause the temperature of the oil to be reduced significantly more rapidly than does the conventional blanket (plot II).

At time=17 minutes, the blanket under test is removed. At this time, it was observed that the conventional blanket (plot II) had reduced the oil temperature to 330° C. This temperature is still above the auto-ignition temperature of the oil, and it was observed that the fire was re-struck. Thus, this blanket failed the test under BS 1869:1997. However, at time=17 minutes, the blankets according to the invention had reduced the oil temperature significantly more (to less than 310° C. in the case of plot I and to slightly above this temperature in the case of plot III). The oil temperature is less than its auto-ignition temperature, and removal of the blanket does not cause the fire to re-strike.

It is important that the fire blanket creates an air-tight barrier to starve the fire of oxygen. Thus, the underlying fabric must be able to remain wetted by the melt or solution in order to provide the air barrier once the chemically active component has dripped through onto the seat of the fire. Clearly, in such circumstances, it is necessary to select the fabric carefully in terms of its weight (gsm), its weave and the fibre denier etc. Typically the fabric will retain some of the melted chemically active component by surface tension and thus seal holes in the weave and so create at least a partially air-tight barrier to starve the fire of oxygen. Although a woven cloth is preferred, it will be understood that in some situations a non-woven felt may be used. The fabric weave density is the key to maintaining air exclusion.

A typical fabric will have a simple 1×1 weave with a 50% cotton/50% polyester thread. A suitable fabric is made by Copland Fabric, Burlington, N.C. 27216 under their style code 10015/1. However, it will be understood that tea towel or bed sheet type materials may be used and, rather than a simple weave, cross woven or bow weave materials could be used. Typically, in the fabric the thread, both in weft and warp, will be about 35/1 denier and there will be around 45 to 50 threads per inch. However, 50 threads per inch is preferred in order to provide a fabric which is tight enough to retain the chemically active agent when stored but sufficiently open to allow the agent to drip through to a fire when melted.

The primary means of fire extinguishing by a fire blanket is by limiting oxygen. However, inclusion of chemically active agents such as sodium acetate trihydrate enhances fire extinguishing action by removing heat and also by reducing fuel (oil) temperatures which also inhibits restrike when the blanket is removed and oxygen is available. The use of the plastic bags 14, for holding the extinguishant, enables the fabric to maintain the oxygen limiting feature whilst acting as a matrix to store, present and distribute the chemically active agent to reduce temperatures. Thus, the specific choice of fabric, the material of the bags 14 and the chemically active agent will depend upon requirements, storage conditions, cost etc.

As alternatives to sodium acetate trihydrate, it may be possible where conditions allow, to use potassium acetate or potassium citrate as the chemically active agent.

1. A fire blanket, comprising
a flexible substrate,
a chemical compound which reacts endothermically when heated and which melts when heated above a first predetermined temperature which is less than the temperature of a fire to be attacked by the blanket,
bag means made of material which ruptures when heated above a second predetermined temperature which is higher than the first predetermined temperature and lower than the temperature of the fire to be attacked, the chemical compound being held in the bag means until the rupture thereof,
the bag means being supported on and by the substrate,
the substrate being configured to be porous to the melted chemical compound to allow the chemical compound to permeate therethrough towards and onto the fire after rupture of the bag means and melting of the chemical compound.

2. A fire blanket according to claim 1, wherein the chemical compound is an alkali metal salt.

3. A fire blanket according to claim 1, wherein the chemical compound has a pH greater than 7.

4. A fire blanket according to claim 3, wherein the chemical compound has a pH greater than 8.

5. A fire blanket according to claim 4, wherein the chemical compound has a pH greater than 9.

6. A fire blanket according to claim 1, wherein the chemical compound releases water when heated.

7. A fire blanket according to claim 1, in which the chemical compound is an aqueous solution of a fire extinguishant.

8. A fire blanket according to claim 1, wherein the first predetermined temperature is greater than 30° C. and less than 70° C.

9. A fire blanket according to claim 8, wherein the first predetermined temperature is about 60° C.

10. A fire blanket according to claim 1, wherein the second predetermined temperature is about 120° C.

11. A fire blanket according to claim 1, wherein the chemical compound is a salt of potassium or sodium.

12. A fire blanket according to claim 1, wherein the chemical compound is selected from the group comprising sodium acetate trihydrate, potassium acetate, and potassium citrate.

13. A fire blanket according to claim 1, wherein the bag means comprises a plurality of separate bags.

14. A fire blanket according to claim 13, in which separate bags are respectively supported in confined positions on and by the substrate.

15. A fire blanket according to claim 14, in which the substrate comprises two layers one superimposed on the other, the two layers being attached to each other to define a plurality of pockets defining the confined positions in which the bags are supported.

16. A fire blanket according to claim 1, in which the quantity of the chemical compound per unit area of the blanket varies across the blanket.

17. A fire blanket according to claim 13, in which the bags are not all of the same size, whereby the quantity of the chemical compound per unit area of the blanket varies across the blanket.

18. A fire blanket according to claim 15, in which the number of pockets per unit area of the blanket varies across the blanket.

19. A fire blanket according to claim 15, in which the bags are triangularly shaped.

20. A fire blanket according to claim 1, wherein
the flexible substrate comprises two layers one superimposed on the other, the layers being attached to each other along an array of lines of attachments some of which extend spaced apart in a first direction and the remainder of which extend spaced apart in a second, transverse direction, whereby the layers together define a cellular construction comprising a plurality of pockets, and
the bag means comprises a plurality of separate bags, each bag being held within a respective one of the pockets.

21. A fire blanket according to claim 20, in which some of the pockets are devoid of the bags.

22. A fire blanket according to claim 20, in which the pockets devoid of the bags are located in one or more edge regions of the blanket, whereby to provide such edge region or regions with greater flexibility and a draping facility.

23. A fire blanket according to claim 20, wherein
the material of the layers is a stitchable material, and
each line of attachment is a line of stitching.

24. A fire blanket according to claim 20, wherein some of the bags contain a greater quantity of the chemical compound than the remainder.

25. A fire blanket according to claim 24, wherein the bags positioned nearer to a central region of the blanket contain more of the chemical compound than the bags positioned further away from that region.

26. A fire blanket according to claim 1, wherein the substrate is woven material.

27. A fire blanket according to claim 1, wherein the substrate is fibreglass material.

28. A fire blanket according to claim 1, wherein the flexible substrate is treated with a fire retardant.

29. A fire blanket according to claim 20, wherein each of the layers is a layer of fabric material.

30. A fire blanket according to claim 23, wherein the material of the stitches is fire resistant.

31. A fire blanket according to claim 29, wherein some of the lines of attachment are arranged in pairs of closely spaced said lines, the flexible fabric material between the lines of each pair defining a preferential folding region for facilitating folding of the blanket into a configuration presenting a folded area substantially of a predetermined width and length, the folded blanket having substantially a predetermined folded thickness.

32. A fire blanket according to claim 31, in combination with a box-shaped container the interior of which presents an area substantially the same as the said folded area of the blanket and a depth substantially the same as the said folded thickness of the blanket for receiving the folded blanket and holding it for deployment onto the fire.

33. A fire blanket according to claim 1, provided with handle means for enabling deployment by a user of the blanket.

34. A fire blanket according to claim 31, in which some of the said pairs of lines of attachment extend in said first direction and the remainder thereof extend in said second transverse direction, at least some of the pairs of lines of attachment intersecting to divide the blanket into regions each having an area approximately the same as the said area of the container.

35. A method of making a fire blanket, comprising the steps of
laying out a first layer of blanket material,
placing thereon in predetermined positions a plurality of sealed bags of predetermined size made of plastics material which rupture when heated at least to a first predetermined temperature which is lower than the temperature of a fire to be attacked by the blanket, each sealed bag containing a chemically active extinguishing compound which reacts endothermically when heated and which melts at a second predetermined temperature lower than the first predetermined temperature,
placing a second blanket layer over the sealed bags on the first layer, and
attaching the two blanket layers together along lines of attachment which pass between the sealed bags, some of the lines of attachment being spaced apart and extending in a first predetermined direction and the remainder thereof being spaced apart and extending in a second, transverse direction,
whereby the lines of attachment cause the layers to form pockets in which are disposed the sealed bags,
the blanket material being porous to the melted chemical compound to allow permeation of the melted chemical compound through the blanket material onto the fire after rupture of the sealed bags.

36. A method according to claim 35, in which the blanket material is a woven fabric material.

37. A method according to claim 35, including the step of treating the blanket material with a fire retardant.

38. A method according to claim 35, wherein the chemical compound is selected from the group comprising sodium acetate trihydrate, potassium acetate and potassium citrate.

39. A method according to claim 35, in which each line of attachment is a line of stitching.

40. A method according to claim 35, in which the step of attaching the layers of blanket material along the lines of attachment positions some of the lines of attachment in pairs of closely spaced lines which define longitudinally extending regions of the material providing preferential regions for folding the blanket to allow it to be stored in a container of predetermined size.

41. The fire blanket according to claim 7, in which the chemical compound is an aqueous solution of an alkali metal salt.
